(19) United States
(12) Patent Application Publication
(10) Pub. No.: US 2021/0229253 A1
(43) Pub. Date: Jul. 29, 2021

(54) MULTI-PURPOSE FOLDING TOOL

(71) Applicant: WARNER MANUFACTURING COMPANY, Plymouth, MN (US)

(72) Inventors: David R. HENKE, Maple Grove, MN (US); Eric A. ELLINGBOE, Dubuque, IA (US); Jeffery J. TIGGES, Dubuque, IA (US)

(21) Appl. No.: 17/233,460

(22) Filed: Apr. 17, 2021

Related U.S. Application Data
(63) Continuation of application No. 16/691,188, filed on Nov. 21, 2019.
(60) Provisional application No. 62/770,564, filed on Nov. 21, 2018.

(51) Int. Cl. B25F 1/04; B26B 1/02; B26B 11/00

(52) U.S. Cl. CPC B25F 1/04; B25G 1/085; B26B 11/006; B26B 1/02

(57) ABSTRACT

A hand tool includes an elongate handle having first and second side walls defining first and second edges and first and second ends, and a channel formed between the side walls and extending through the first edge. The hand tool also includes an elongate tool member secured by a pivot to the first end of the handle, whereby the tool member is pivotable between a folded position, and an extended position. The hand tool further includes a utility knife secured by the pivot at the first end thereof to the first end of the handle.

### FIELD

The present disclosure relates to tools, in particular multi-purpose, folding tools and methods of using the tools.

### BACKGROUND

A wide variety of tools have been developed in the past for use during painting operations to perform such tasks as scraping, spreading, cutting, opening paint cans, and the like. Generally, these tools are designed such that a tool is able to perform a single task, or they are designed such that a tool performs multiple tasks. In many instances, a multi-task tool is preferred since it reduces the number of tools which need to be used, thus reducing cost to the user and making the painting operation easier.

A problem with these conventional tools, whether single task or multiple task, is that they are rather large and bulky, making them difficult, if not impossible, to be conveniently carried by the user so as to be ready for use if the need arises, and making them difficult to store when not in use. Further, many of these tools have blade portions with sharp edges and points, making them dangerous to both the user and others, particularly while ascending and descending ladders, scaffolding, and the like. Often times with tools of this sort, a separate carrying pouch or sheath, usually made of leather, is utilized to carry or encase the blade portion of the tool, with the pouch being worn by the user by being secured to the user's belt, in order to protect the user from the blade portion. However, the pouch is an added expense in addition to the expense of the tool, and often times gets in the way of the user.

What has been needed then is a tool having a multi-purpose locking blade, which can fold into a handle thus making it safer while ascending and descending ladders, scaffolding, and the like, and which is specifically designed for one-handed operation.

### SUMMARY

Some embodiments include a hand tool including an elongate handle having first and second side walls defining first and second edges and first and second ends, and a channel formed between the side walls and extending through the first edge. The hand tool also includes an elongate tool member secured in the elongate channel by a pivot to the first end of the handle, whereby the blade is pivotable between a folded position, and an extended position. The hand tool additionally includes a utility knife secured by the pivot at the first end thereof to the first end of the handle.

Other embodiments include a tool including a handle having first and second side walls defining a first edge, and a channel formed between the side walls and extending through the first edge. The tool also includes a tool member pivotally secured in the channel of the handle, the tool member being pivotable between a folded position, and an extended position, and the tool member defining first and second side surfaces and a first longitudinal edge. The tool additionally includes a utility knife secured by the pivot at the first end thereto to the first end of the handle.

More embodiments include a method in assembling a hand tool. The method includes securing an elongate tool member by a pivot at a first end thereof to a first end of the handle; and securing a utility knife by the pivot at the first end thereof to the first end of the handle.

### BRIEF DESCRIPTION OF THE DRAWINGS

References are made to the accompanying drawings that form a part of this disclosure, and which illustrate embodiments in which devices, systems and methods described herein can be practiced.

FIG. 1 is a schematic view of a first embodiment of a multi-purpose folding tool.

FIG. 2A is a front side view of a second embodiment of a multi-purpose folding tool in a folded position.

FIG. 2B is a front side view of the multi-purpose folding tool of FIG. 2A, with a screwdriver bit holder being in an unfolded position.

FIG. 2C is a front side view of the multi-purpose folding tool of FIG. 2A, with a multiuse blade being in an unfolded position.

FIG. 2D is a front side view of the multi-purpose folding tool of FIG. 2A, with a utility blade holder being in an unfolded position.

FIG. 3A is a top perspective view of the multi-purpose folding tool of FIG. 2A.

FIG. 3B is a top perspective view of the multi-purpose folding tool of FIG. 2B.

FIG. 3C is a top perspective view of the multi-purpose folding tool of FIG. 2C.

FIG. 3D is a top perspective view of the multi-purpose folding tool of FIG. 2D.

FIG. 4 is an exploded view of the multi-purpose folding tool of FIG. 2A.

FIG. 5A is a perspective view showing a rear side wall of the multi-purpose folding tool of FIG. 4.

FIG. 5B is a perspective view showing a multiuse blade of FIG. 4, with a finger actuation loop.

FIG. 5C is a perspective view showing a rear locking mechanism of FIG. 4.

FIG. 5D is a perspective view showing a further embodiment of the multiuse blade, with a finger actuation knob.

FIG. 6A is a perspective view showing a front side wall of the multi-purpose folding tool of FIG. 4.

FIG. 6B is a perspective view showing a rear part of a utility blade holder of FIG. 4.

FIG. 6C is a perspective view showing a front locking mechanism of FIG. 4.

FIG. 6D is a perspective view showing the screwdriver bit holder of FIG. 4.

FIG. 6E is a perspective view showing a spare tool head retainer of FIG. 4.

FIG. 7A is a right end view of the multi-purpose folding tool of FIG. 2A, when in a folded position.

FIG. 7B is a cross sectional view of the right end of the multi-purpose folding tool of FIG. 8A along line 8b-8b.

FIG. 7C is a perspective view of a rear hammer cap of FIG. 4.

FIG. 7D is a perspective view of a front hammer cap of FIG. 4.

FIG. 7E is right end view of a further embodiment of the multiuse blade, with an integral hammer cap.

FIG. 8 is a schematic view of a clip attached to a side wall surface of a tool handle.

FIG. 9A is a perspective view showing a locking push pin interacting with an attachment end of a tool head, when the tool head is positioned in an unlocked position.

FIG. 9B is a perspective view showing the locking push pin of FIG. 9A interacting with the attachment end of the tool head, when the tool head is positioned in a locked position.

FIG. 10 is a perspective view showing a further embodiment of the front side wall of the multi-purpose folding tool of FIG. 4.

FIG. 11 is a perspective view showing a further embodiment of a locking mechanism of the multi-purpose folding tool of FIG. 4.

### DETAILED DESCRIPTION

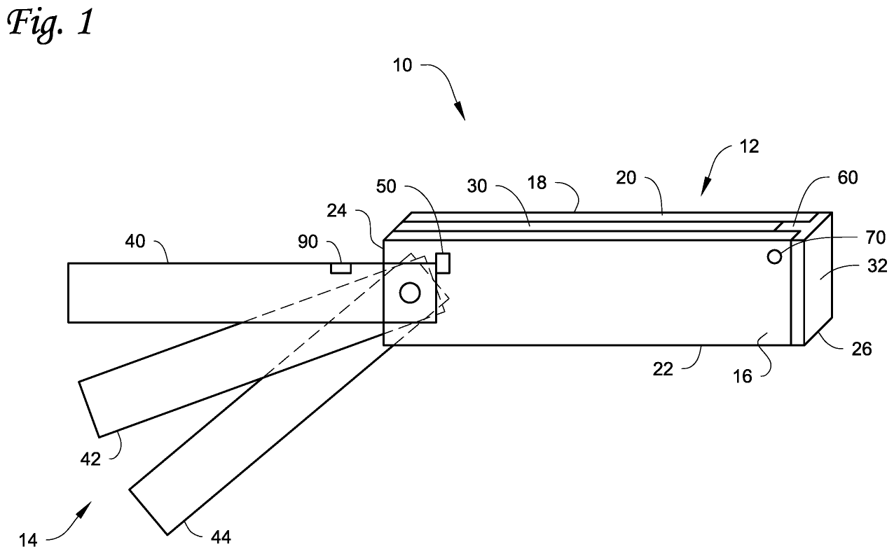

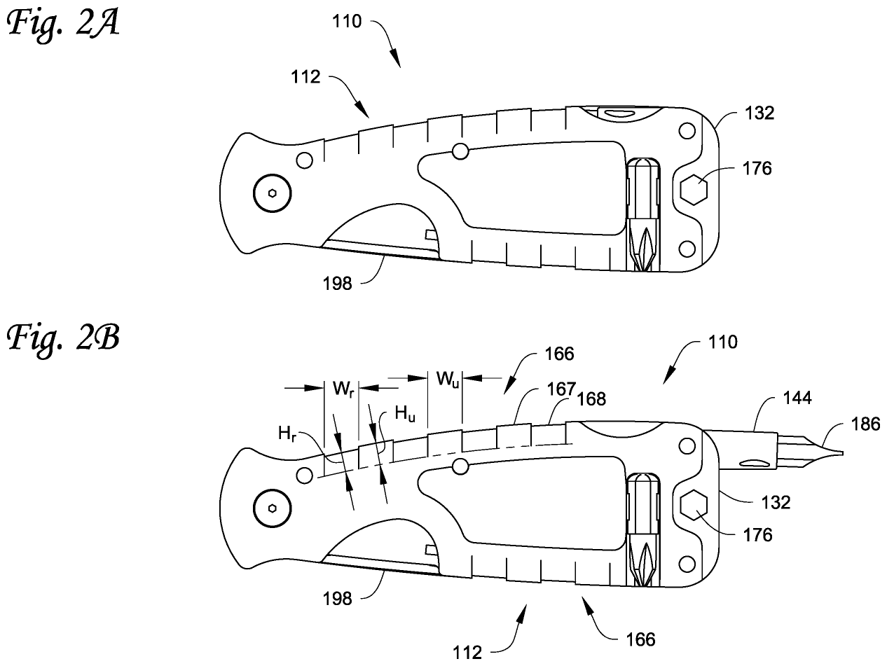

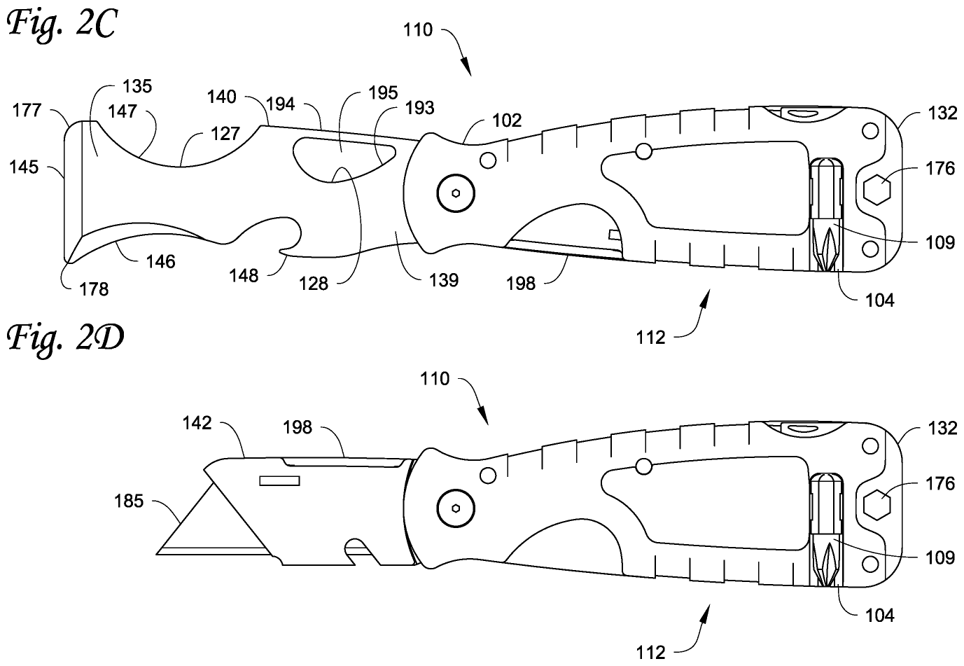

When used herein, the term “multi-purpose folding tool” refers to a multi-purpose tool that is used not only in painting industry but also in other industries and for other purpose. The term “tool” means any hand tools or devices. The term “tool head” or “tool heads” means a part of a tool designed for performing any industrial operation, such as for example a cutting operation or a spreading operation. The terms “above,” “on,” “under,” “top,” “bottom,” “upper,” “lower,” “front,” “rear,” “left,” “right” and the like used herein are in reference to the relative positions of the composite pole and its constituent parts, in use when oriented as in FIGS. 1, 2A-D, 3A-D, 4, 5A-D, 6A-E, 7A-E, 8 and 9A-B.

Referring now to FIG. 1, a first embodiment of a multi-purpose folding tool is illustrated. The tool designated by the reference number 10 includes a handle 12 and a plurality of tool heads 14 secured to the handle 12.

The handle 12 is generally elongate and is formed from a suitable rigid, metallic, wood or plastic material. One embodiment of plastic material is a lightweight nylon plastic so as to make the tool 10 light in weight. The handle 12 includes a front side wall 16 and a rear side wall 18 which define a top edge 20 and a bottom edge 22 and generally a left end 24 and a right end 26. The front and rear side walls 16, 18 are rigidly connected together by fasteners to form a longitudinal channel 30 between the front and rear side walls 16, 18. The channel 30 extends between the top and bottom edges 20, 22 and from the left end 24 to the right end 26.

In the embodiment depicted in FIG. 1, the plurality of tool heads 14 includes a first tool head 40 and a second tool head 42 attached to the left end 24 and a third tool head 44 attached to the right end 26. However, it is to be understood that the plurality of tool heads 14 can be attached to the left end 24, the right end 26, the top edge 20, the bottom edge 22, the front side wall 16, the rear side wall 18 or the other locations of the tool 10. Additionally, it is to be understood that more or fewer members could be pivotally attached to the 10 to augment the operation of the first tool head 40, the second tool head 42 and the third tool head 44. These members include a flexible putty blade, an electrician's screwdriver blade, and/or a screwdriver can closer blade. These members would be pivotally attached to the handle and be able to fold into the channel, along with the first, second and third tool heads.

Optionally, a hammer cap mechanism 32, preferably made of metal, is secured to the right end 26 for nail setting purposes. In one embodiment, the hammer cap mechanism includes stainless steel. The hammer cap mechanism 32 can include a spacing mechanism 60 extending from the right end 26 of the tool 10 toward the left end 24. The spacing mechanism 60 is disposed within the channel 30 between the side walls 16, 18 for spacing apart two adjacent wall surfaces inside the channel 30 at the right end 26.

It is to be understood that the spacing mechanism 60 can be used independent of the hammer cap mechanism 32. In some embodiments, the spacing mechanism 60 includes a plurality of spacers, and the spacers can be disposed at the left end 24, at the right end 26 or at both the left end 24 and the right end 26. In one embodiment, the number of spacers disposed at the right end 26 equals the number of plurality of tool heads 14 attached to the left end 24.

Optionally, at least one of the plurality of tool heads 14 includes a locking mechanism 50 for locking the at least one tool head in a folded or extended position. In some embodiments, the locking mechanism 50 is configured to lock the at least one tool head in an extended position, a folded position, or both positions.

Optionally, a fastening mechanism 70 is used to secure side walls together. In some embodiments, the fastening mechanism 70 includes a plurality of fasteners that secures the side walls together at both the left end 24 and the right end 26. In other embodiments, one or more fasteners extend between the side walls, securing the hammer cap mechanism 32 in place and securing the side walls together at the right end 26.

Optionally, the tool 10 includes a finger actuation mechanism 90 for a user to actuate pivotal movement of one of the plurality of tool heads 14 by a single hand, when the one of the plurality of tool heads 14 is pivoted from the folded position to the extended position. It is to be understood that the finger actuation mechanism 90 can take various forms, including an actuation loop, an actuation knob, etc.

Referring now to FIGS. 2A-D, 3A-D and 4, a multi-purpose folding tool 110 has a handle 112 and a plurality of tool heads 114 secured to the handle 112. The handle 112 includes a front side wall 116 and a rear side wall 118 which define a top edge 120 and a bottom edge 122 and generally a left end 124 and a right end 126.

The handle 112 is generally elongate and generally tapered from the right end 126 of the tool 110 to the left end 124, with a neck section 102 formed at the left end 124 for a user to apply fingers to have a firm grip. The handle 112 can be formed from a suitable rigid, metallic, wood or plastic material or a combination thereof. The metallic material may include but not limited to aluminum or stainless steel. In some embodiments, the handle is formed of stainless steel. In other embodiments, the handle 112 is formed of a lightweight plastic material for example nylon to make the tool 110 light in weight.

The front and rear side walls 116, 118 are rigidly connected together by fasteners to form a longitudinal channel 130 between the front and rear side walls 116, 118. The channel 130 extends between the top and bottom edges 120, 122 and from the left end 124 to the right end 126 of the tool 110.

The plurality of tool heads 114 includes a first tool head, such as a multiuse blade 140 and a second tool head, such as a utility knife blade holder 142 attached to the left end 124 of the tool 110, and a third tool head, such as a foldable screwdriver bit holder 144 attached to the right end 126 of the tool 110.

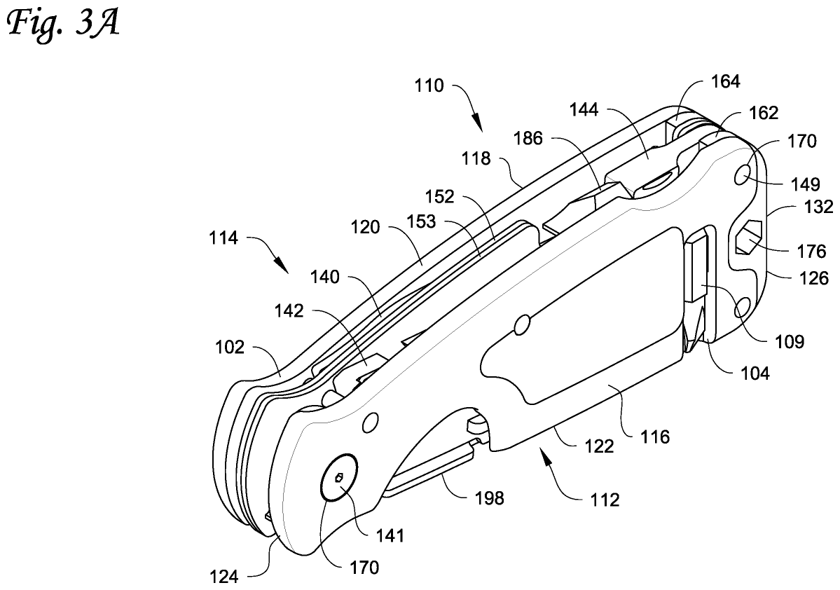

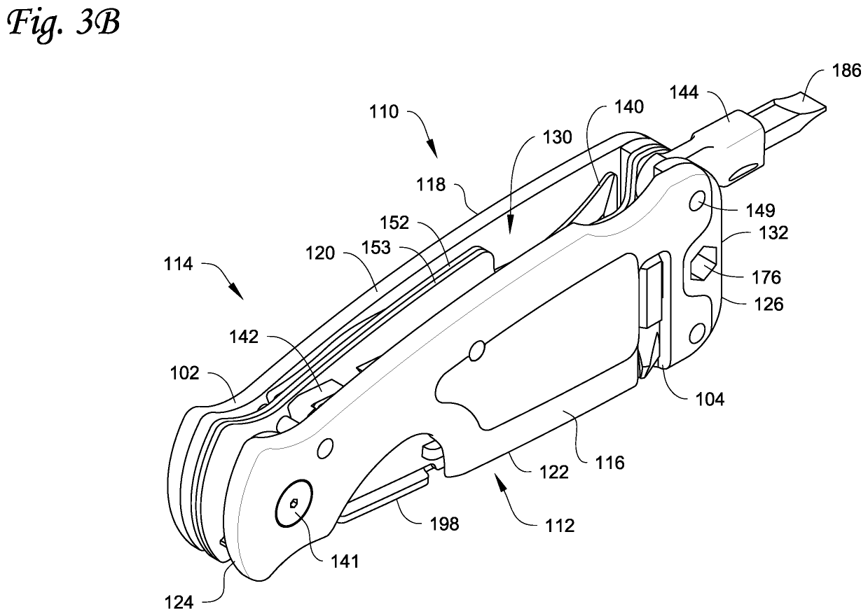

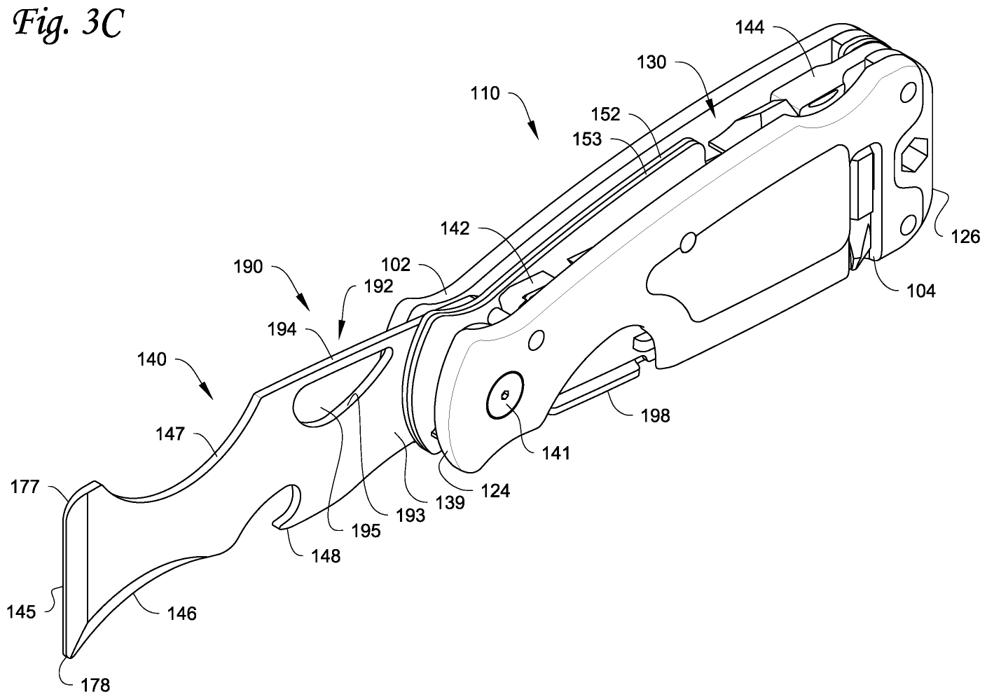

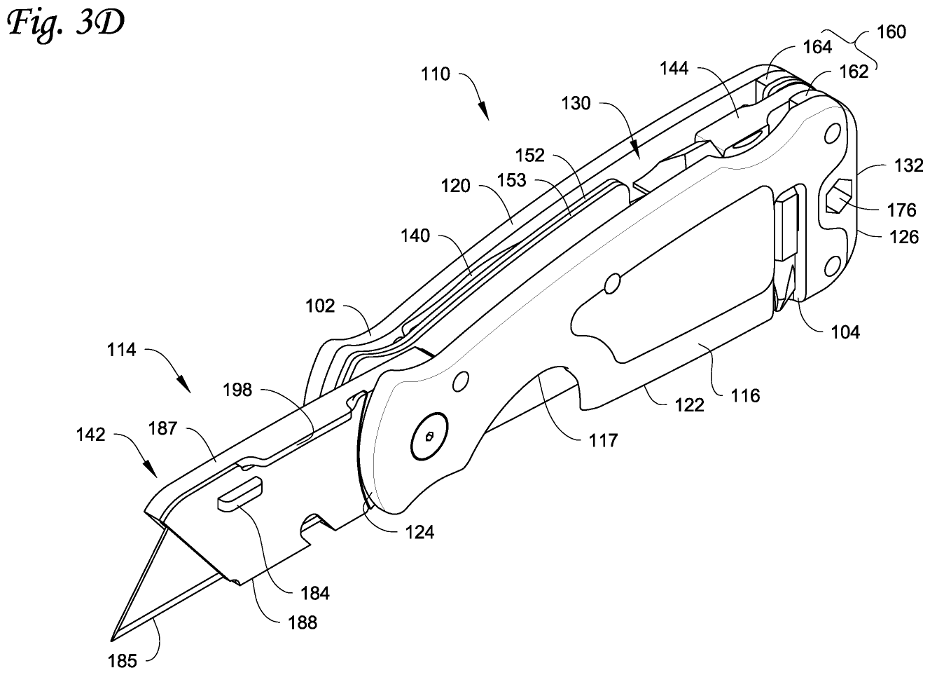

In the embodiment depicted in FIGS. 2A-D, 3A-D and 4, the multiuse blade 140, like the handle 112, is generally elongate, and is made of a metallic material so as to be generally rigid. The multiuse blade 140 can be connected to the handle 112 between the side walls 116, 118 by a fastening mechanism 170. In the depicted embodiment, the multiuse blade 140 is connected to the handle 112 by a first pivot pin 141 located at the left end 124 of the tool 110 so as to permit the multiuse blade 140 to pivot between an extended position, shown in FIGS. 2C and 3C, and a folded position wherein the multiuse blade 140 is disposed within the channel 30, shown in FIGS. 2A-B and D and 3A-B and D. The multiuse blade 140 has an attachment end 139 attached to the handle 112 and a free end opposite to the attachment end 139. The multiuse blade 140 includes a concave edge 147 having a large, concave portion between the ends of the multiuse blade 140, suitable for receive and scrape the surface of a roller to aid in cleaning the roller of paint. The multiuse blade 140 further includes a side blade 146, which acts as a radius scraper and a cutting edge. The orthogonal blade 145 and the concave edge 147 are connected to each other by a large radiused portion 177 suitable for acting as a paint can opener, and the orthogonal blade 145 and the side blade 146 are connected to each other forming an acute angle such that a small radiused portion 178 is formed to define a small radius corner tip, suitable for acting as a crack cleaner point. In addition, the multiuse blade 140 includes a bottle opener 148 located between the side blade 146 and the attachment end 139. In the depicted embodiment, one side 135 of the multiuse blade 140 is beveled at the orthogonal blade 145 and the side blade 146, and the other side opposing to the side 135 of is not beveled. This allows the orthogonal blade 145 to act as not only a scraper but also a spreader.

The utility knife blade holder 142 can be connected to the handle 112 between the side walls 116, 118 by a fastening mechanism 170. In the depicted embodiment, the utility knife blade holder 142 is connected to the handle 112 by the first pivot pin 141 so as to permit the utility knife blade holder 142 to pivot between an extended position, shown in FIGS. 2D and 3A and D, and a folded position wherein the utility knife blade holder 142 is disposed within the channel 30, shown in FIGS. 2A-C and 3A-C. In the embodiment depicted in FIGS. 2A-D, 3A-D and 4, the utility knife blade holder 142 is positioned on a front side of the multiuse blade 140. The utility knife blade holder 142 includes a blade cover 188 and a blade housing 187 cooperate with each other to form the holder, which is configured to hold a utility knife blade 185.

The blade housing 187 has a finger actuation rib 198 formed at a front side of its bottom edge. As described in more detail below, the finger actuation rib 198 is designed to assist actuating pivotal movement of the utility knife blade holder 142 to extend the utility knife blade holder 142 from the folded position to the extended position. In addition, the blade cover 188 has an elongate grip 184 formed at a front side of its bottom edge when the utility knife blade holder 142 is in the folded position. In the depicted embodiment, the elongate grip 184 acts to assist removal of the blade cover 188 during installation or replacement of the utility knife blade 185.

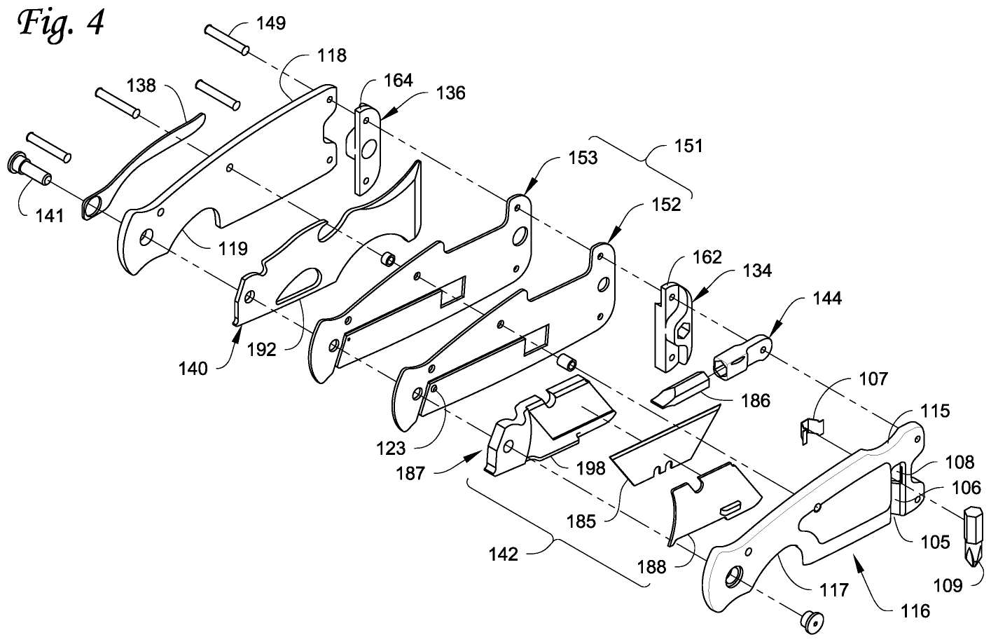

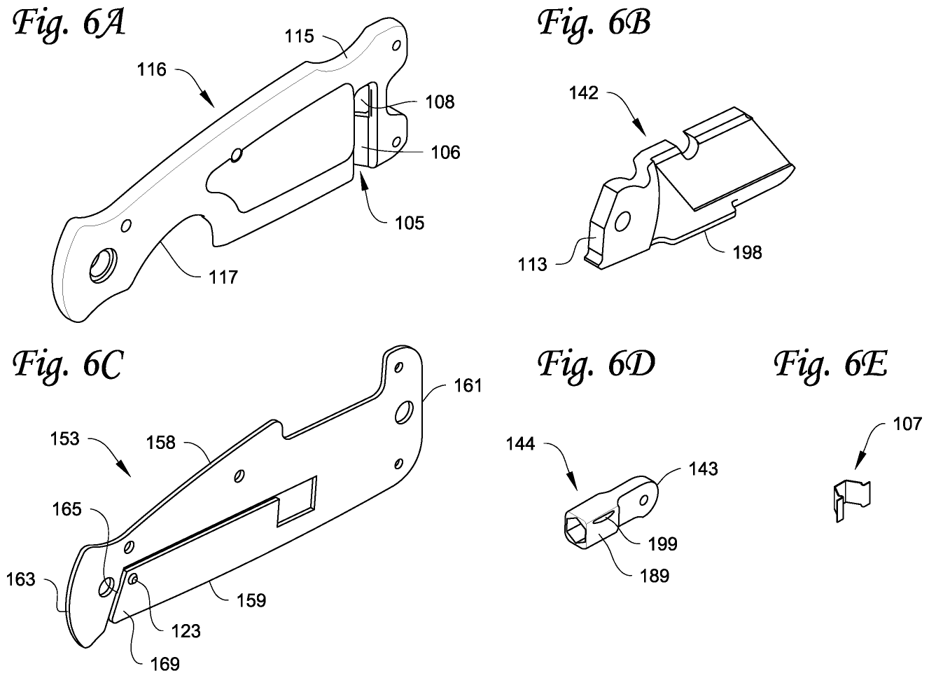

The foldable screwdriver bit holder 144 can be connected to the handle 112 between the side walls 116, 18 by a fastening mechanism 170. In the depicted embodiment, the foldable screwdriver bit holder 144 is connected to the handle 112 by a second pivot pin 149 located at the right end 126 of the tool 110 so as to permit the foldable screwdriver bit holder 144 to pivot between an extended position, shown in FIGS. 2B and 3B, and a folded position wherein the foldable screwdriver bit holder 144 is disposed within the channel 30, shown in FIGS. 2A and C-D and 3A and C-D. The foldable screwdriver bit holder 144 is positioned within the channel 130 along the top edge 120 when in the folded position. Referring to FIGS. 4 and 6D, the foldable screwdriver bit holder 144 is configured to have an inner contour suitable to receive a screwdriver bit that has a hexagon bit stem. However, it is to be understood that the inner contour of the foldable screwdriver bit holder 144 can have other shapes as desired.

Referring to FIGS. 2B, 3B and 4, a screwdriver bit 186 is held in the foldable screwdriver bit holder 144. In the embodiment depicted, the screwdriver bit 186 is a screwdriver bit having a hexagon shape stem and a slot head. However, it is to be understood that the foldable screwdriver bit holder 144 can be configured to hold any types of screwdriver bits. In some embodiments, the foldable screwdriver bit holder 144 is configured to hold a screwdriver bit configured for quickly tightening loose screws and bolts.

The tool 110 can include a spare tool head retainer and a tool head retained in the retainer. In the embodiment depicted in FIGS. 2A-D, 3A-D, 4 and 6A and E, the spare tool head retainer 104 is incorporated into the handle 112 of the tool 110 for retaining a screwdriver bit. The spare tool head retainer 104 includes an opening 105 and a clip spring 107 secured at the edge of the opening 105. The opening 105 is located in an area adjacent to the right end 126 of the tool 110 and is positioned generally transverse to the top and bottom edges 120, 122 of the handle 112. The opening 105 extends from a section closer to the top edge 120 and passes through the bottom edge 122 to its very bottom. An upper portion of the opening 105 is a pass-through opening 108 configured to receive the clip spring 107 and allow the clip spring 107 to be secured in pass-through opening 108, and a lower portion of the opening 105 is a groove 106 having a rear wall extending rearwardly into the channel 130. When the spare tool head retainer 104 is assembled, the clip spring 107 is received in the pass-through opening 108 and secured to the edges of the pass-through opening 108.

In the embodiment depicted, the clip spring 107 is configured to secure a screwdriver bit that has a hexagon bit stem. However, it is to be understood that various configurations of the spare tool head retainer 104 can be used to retain screwdriver bits that have other shapes, and to secure other tool heads in general. Additionally, it is to be understood that the locations of the spare tool head retainer 104 can vary as desired.

As shown in FIG. 4, when in use, a spare tool head 109 is snapped into the clip spring 107 and retained in the spare tool head retainer 104. In the embodiment depicted in FIGS. 2A-D, 3A-D and 4, the spare tool head 109 is a screwdriver bit with a Philips head. However, it is to be understood that the spare tool head 109 can be other types of screwdriver bits and other tool heads in general.

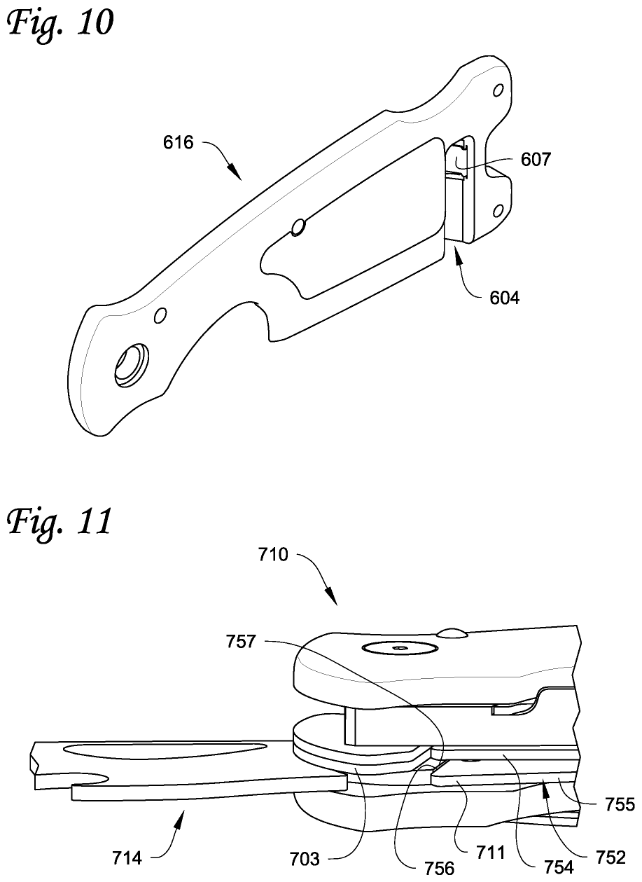

In a further embodiment as shown in FIG. 10, a front side wall 616 of the multi-purpose folding tool may include an integrated spare tool head retainer 604. Like the spare tool head retainer 104, the retainer 604 is incorporated into the handle of the tool for retaining a screwdriver bit. One difference is that the retainer 604 includes an integral clip spring 607 that is molded into the side wall 616 of the handle. When in use, the spare tool head 109 in FIG. 4 can be snapped into the clip spring 607 and retained in the spare tool head retainer 604.

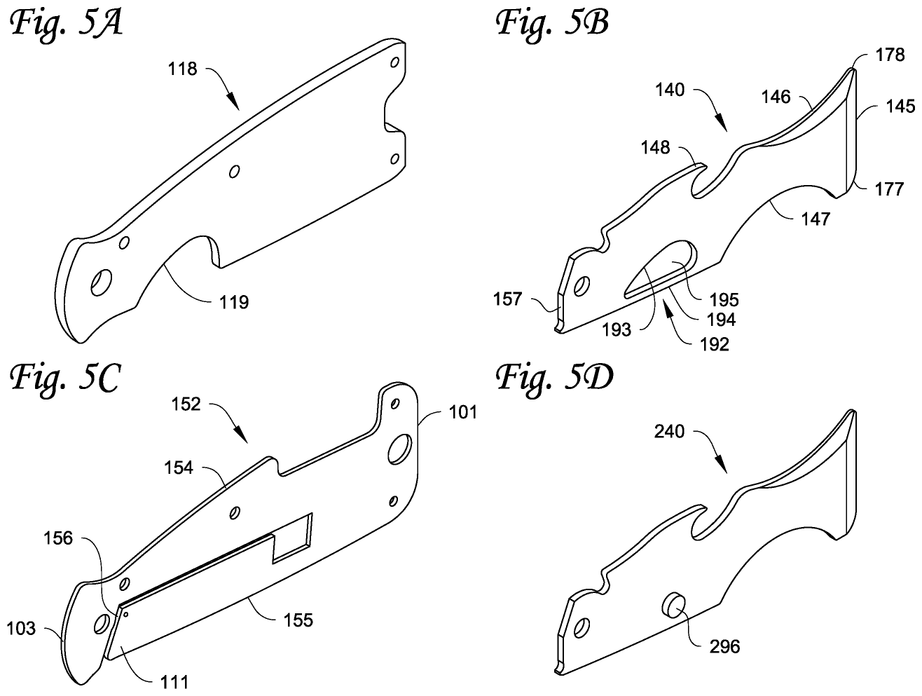

As shown in FIGS. 5A-B and 6A-B, a front concave notch 117 is formed in the front side wall 116 from the bottom edge 122 toward the top edge 120 and a rear concave notch 119 is formed in the rear side wall 118 at a location corresponding to the front concave notch 117 to allow a portion of a finger, such as a thumb, to fit in. In the embodiment depicted in FIGS. 2A-D, 3A-D, 4, 5A-B and 6A-B, the front concave notch 117 and the rear concave notch 119 respectively extend a first distance from the bottom edge 122 from a location closer to the left end 124 of the tool 110 toward the top edge 120 and the right end 126 until passing about one third of the width of the handle 112, then turn toward the bottom edge 122 and extend a second distance to the bottom edge 122. In some embodiments, the first distance is greater than the second distance. However, it is to be understood that the front and rear concave notches 117, 119 can have other configurations such as round, rectangular or triangular, as long as the design is suitable for a finger, such as a thumb, to fit in.

In addition to the front and rear concave notches 117, 119, a smaller notch 115 is formed at the top edge of the front side wall 116, allowing at least a portion of a finger to access the foldable screwdriver bit holder 144 folded inside the channel 130.

Referring to FIGS. 5A-B, one or more of the tool heads 114 can include a finger actuation mechanism 190 for a user to actuate pivotal movement of the tool head by one hand, when the one of the tool heads 114 is pivoted from the folded positon to the extended position.

For example, referring to FIGS. 2A-D, 3A-D, 4 and 5A-B, the multiuse blade 140 include finger actuation loop 192 acting as the finger actuation mechanism 190. The finger actuation loop 192 is located on the same side as the concave edge 147 and between the concave edge 147 and the attachment end 139 of the multiuse blade 140. The finger actuation loop 192 includes a cutout area 195 at a bottom edge of the multiuse blade 140 when the multiuse blade 140 is disposed in the folded position. The cutout area 195 is defined by a loop member 194 at its outer side closer to the bottom edge of the multiuse blade 140 when the multiuse blade 140 is disposed in the folded position and extend inwardly toward the other edge of the multiuse blade 140, such that when the multiuse blade 140 is positioned in a folded position, an inner edge 193 of the cutout area 195 opposite to the loop member 194 generally correspond to the curvature of the rear concave notch 119 formed on the bottom edge of the rear side wall 118 to assure proper fit of the finger, thumb within the cutout area 195 to actuate the pivotal movement of the multiuse blade 140 by only one hand. In some embodiments, the most inner point 128 on the inner edge 193 of the cutout area 195 toward the other edge of the multiuse blade 140 is generally aligned with the most inner point 127 on the concave edge 147. However, it is to be understood that, the inner edge 193 of the cutout area 195 can have a shape that does not correspond to the curvature of the rear concave notch 119, as long as this shape allows the user's finger, such as a thumb, to fit in the cutout area 195 and apply force on the loop member 194 to actuate the pivotal movement of the multiuse blade 140 by one hand.

Referring to FIGS. 2A-D, 3A-D, 4 and 6A-B, the blade housing 187 of the utility knife blade holder 142 includes a finger actuation rib 198 as the finger actuation mechanism 190. The finger actuation rib 198 is formed frontwardly from a side of the bottom edge of the blade housing 187 when the utility knife blade holder 142 is disposed in the folded position. The finger actuation rib 198 is positioned to be accessible from the front concave notch 117 formed on the bottom edge of the front side wall 116 such that when the utility knife blade holder 142 is in the folded position, the finger actuation rib 198 is exposed to allow a finger, such as a thumb, to apply force on the finger actuation rib 198 to actuate the pivotal movement of the utility knife blade holder 142.

Referring now to FIGS. 6A and 6D, the foldable screwdriver bit holder 144 includes a finger actuation groove 199 acting as the finger actuation mechanism 190. The finger actuation groove 199 is formed on the top of a front wall 189 of the screwdriver bit holder 144, when the foldable screwdriver bit holder 144 is disposed in the folded position. The finger actuation groove 199 is positioned to be accessible from the smaller notch 115 formed on the top edge of the front side wall 116 such that when the foldable screwdriver bit holder 144 is in the folded position, the finger actuation groove 199 is exposed to allow a finger, such as a thumb, to apply force on the finger actuation groove 199 to actuate the pivotal movement of the foldable screwdriver bit holder 144.

In an alternative embodiment as shown in FIG. 5D, the multiuse blade 240 can include a finger actuation knob 296 acting as a finger actuation mechanism 290. The 296 can be disposed on a rear side surface of the multiuse blade 240 such that when the multiuse blade 240 is in the folded position, the finger actuation knob 296 is accessible from a rear concave notch. It should be understood that although the finger actuation knob 296 is shown as being round, other knob shapes, such as rectangular or square, can be used as desired.

When in use, with the tool heads 114 in their folded position and the aid of the finger actuation mechanism 190, the user can simply hold the tool in one hand, and using the same hand, use a thumb or finger to actuate the finger actuation mechanism 190, so as to pivot the respective tool head 114 to the extended position where it is locked in place.

It is to be understood that the finger actuation mechanism 190, 290 can take various forms as long as the structure allows a user's finger to actuate the pivotal movement of the tool head. It is to be understood that the location and positioning of the finger actuation mechanism 190 can vary as long as it can be used to actuate the pivotal movement of the tool head.

A locking mechanism 150 can be incorporated in the tool 110 to securely and disengageably hold one or more tool heads 114 in place, when the one or more of the tool head 114 is disposed in the extended position or the folded position. In the embodiment depicted in FIGS. 4, 5B-C and 6B-C, the locking mechanism 150 takes the form of a spring plate mechanism. The spring plate mechanism 151 in the depicted embodiment includes a first spring late 152 and a second spring plate 153. The first and second spring plates 152, 153 have a similar configuration and are used to respectively lock the multiuse blade 140 and the utility knife blade holder 142 in their extended positions.

Referring to FIGS. 4 and 5B-C, the first spring plate 152 has a right end 101, and a fixed arm 154 and a spring arm 155 extending leftwardly from the right end 101. A left end 103 of the fixed arm 154 is fixed, and a left end 111 of the spring arm 155 is not fixed. When no external forced is applied to the left end 111 of the spring arm 155, the left end 111 is naturally positioned rearwardly and offset from the left end 103 of the fixed arm 154. When in folded position, the front surface of the multiuse blade 140 biases the left end 111 of the spring arm 155 so that the left end 111 is generally aligned with the left end 103 of the fixed arm 154, as shown in FIG. 5C. When the multiuse blade 140 is pivoted into the extended position, the biasing force from the multiuse blade 140 is removed. The left end 111 of the spring arm 155 springs rearwardly with an engagement surface 156 of the left end 111 configured to move into a position to engage an engaged surface 157 formed on the multiuse blade 140, thereby holding the multiuse blade 140 in the extended position.

Referring to FIGS. 5A-C, when the multiuse blade 140 is locked in the extended position, the rear surface of the spring arm 155 is exposed and accessible through the rear concave notch 119 formed on the bottom edge of the rear side wall 118. To unlock the multiuse blade 140, an external force can be applied by a finger or thumb to press the left end 111 of the spring arm 155 frontwardly and release the engagement between the engagement surface 156 and the engaged surface 157 formed on the multiuse blade 140, thereby allowing the multiuse blade 140 to be folded back into the folded position.

Likewise, referring to FIGS. 4 and 6B-C, the second spring plate 153 has a right end 161, and a fixed arm 158 and a spring arm 159 extending leftwardly from the right end 161. A left end 163 of the fixed arm 158 is fixed, and a left end 169 of the spring arm 159 is not fixed. When no external forced is applied to the left end 169 of the spring arm 159, the left end 169 is naturally positioned frontwardly and offset from the left end 163 of the fixed arm 158. When in folded position, the front surface of the utility knife blade holder 142 biases the left end 169 of the spring arm 159 so that the left end 169 is generally aligned with the left end 163 of the fixed arm 158, as shown in FIG. 6C. When the utility knife blade holder 142 is pivoted into the extended position, the biasing force from the utility knife blade holder 142 is removed. The left end 169 of the spring arm 159 springs frontwardly with an engagement surface 165 of the left end 169 configured to move into a position to engage an engaged surface engaged surface 113 formed on the utility knife blade holder 142, thereby holding the utility knife blade holder 142 in the extended position.

Referring to FIGS. 6A-C, when the utility knife blade holder 142 is locked in the extended position, the front surface of the spring arm 159 is exposed and accessible through the front concave notch 117 formed on the bottom edge of the front side wall 116. To unlock the utility knife blade holder 142, an external force can be applied by a finger or thumb to press the left end 169 of the spring arm 159 rearwardly and release the engagement between the engagement surface 165 and the engaged surface 113 formed on the utility knife blade holder 142, thereby allowing the utility knife blade holder 142 to be folded back into the folded position.

It is to be understood that the first and second spring plates 152, 153 can have different configuration instead of similar configuration, as desired.

Referring to FIG. 11, in an alternative embodiment, a multi-purpose folding tool 710 has a spring plate 752 having a right end (not shown), a fixed arm 754 and a spring arm 755 extending leftwardly from the right end. A left end 711 of the spring arm 755 is not fixed. When no external forced is applied to the left end 711 of the spring arm 755, the left end 711 is naturally positioned rearwardly and offset from a left end 703 of the fixed arm 754. When in folded position, a front part of a tool head biases the left end 711 of the spring arm 755 so that the left end 711 is generally aligned and positioned within the same plane as the left end 703 of the fixed arm 754, similar to a position as shown in FIG. 5C. When the tool head 714 is pivoted into the extended position, the biasing force from the tool head 714 is removed. The left end 711 of the spring arm 755 springs rearwardly with an engagement surface 756 of the left end 711 moving into a position to engage with an engaged surface 757 formed on the tool head 714, thereby holding the tool head 714 in the extended position.

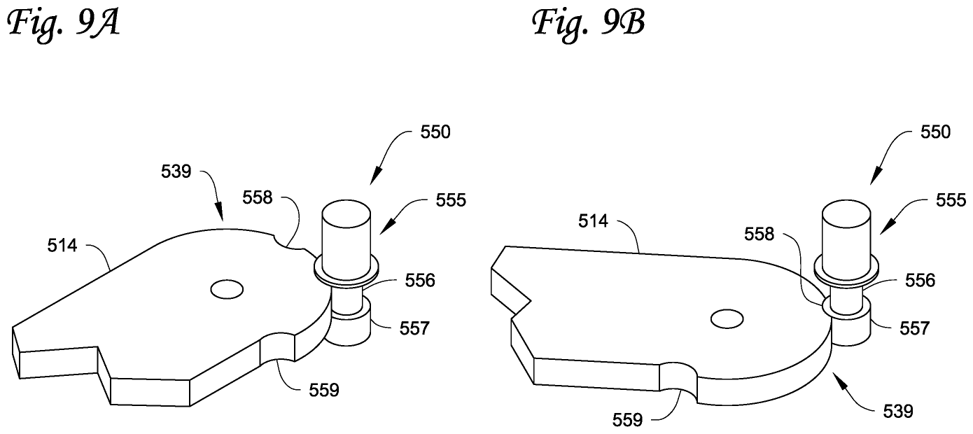

In other embodiments, a locking push pin concept can be used for the locking mechanism to lock one of the tool head in place. In an embodiment depicted in FIGS. 9A-B, a locking mechanism 550 includes a locking push pin 555 that has a thinner diameter portion 556 and a thicker diameter portion 557. One of a plurality of tool heads 514 has a first locking seat 558 located at an end edge of an attachment end 539 of the tool head 514, and a second locking seat 559 located at a side of the attachment end of the tool head 514. When the tool head 514 is in an extended position as shown in FIG. 9B, the thicker diameter portion 557 is received in the first locking seat 558 formed on the attachment end 539 of the tool head 514, locking the tool head 514 in the extended position. When the tool head 514 moves from the extended position to a folded position as shown in FIG. 9A, the thicker diameter portion 557 moves out of the first locking seat 558, and an edge of the fixed end of the tool head 514 moves along the outer surface of the thinner diameter portion 556 until the thinner diameter portion 556 is received in the 559 and the tool head 514 is secured in the folded position.

It is to be understood that other locking mechanisms, including, but not limited to, a lock release lever could be used as desired.

Referring to FIG. 3B, the screwdriver bit holder 144 of the tool can be held in place by friction. In an alternative embodiment, a locking mechanism 150 described above can be used to lock the screwdriver bit holder 144 in place.

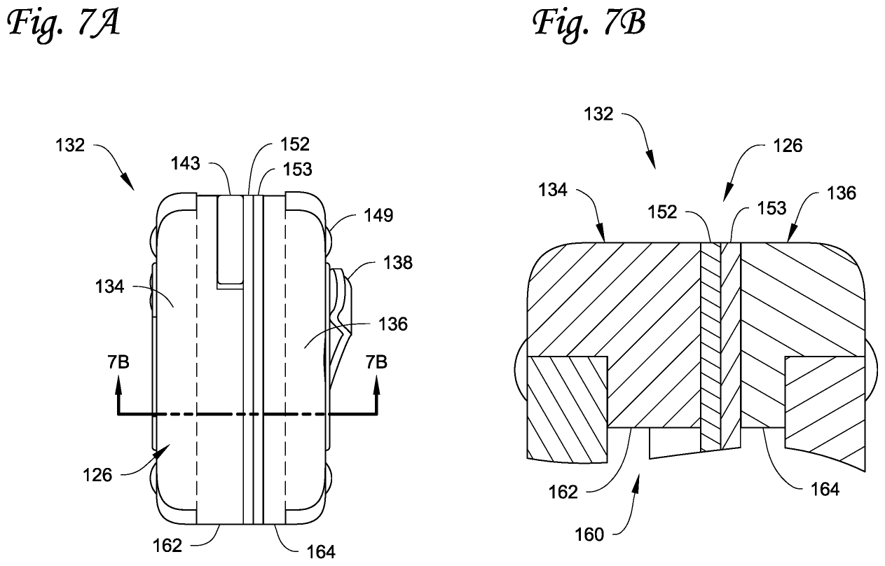

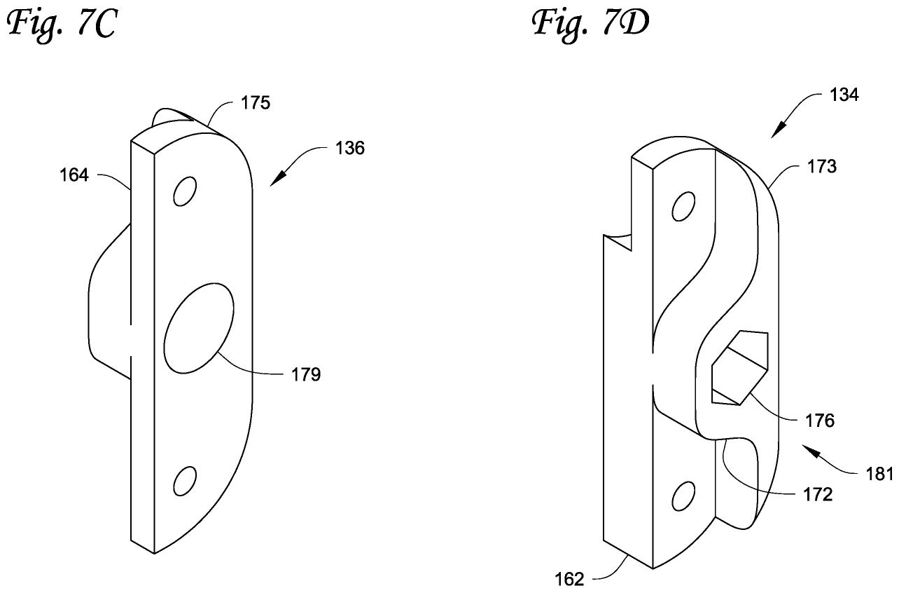

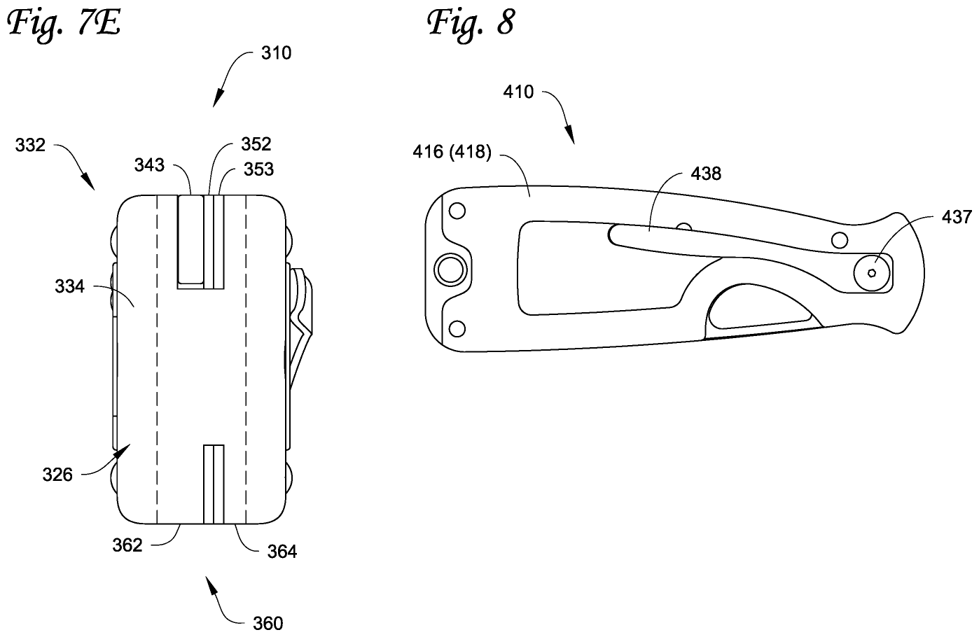

Referring to FIGS. 7A-C, a hammer mechanism 132, preferably made of metal, is secured to the right end 126 for nail setting purposes. The hammer mechanism 132 includes a front hammer cap 134 and a rear hammer cap 136 and a spacing mechanism 160 disposed within the channel 130 between the side walls 116, 118 and extending toward the left end 124 of the tool 110. In the embodiment depicted, the spacing mechanism 160 includes a first spacer 162 extending rearwardly into the channel 130 from an inner edge of the front hammer cap 134 and a second spacer 164 extending rearwardly into the channel 130 from an inner edge of the rear hammer cap 136. The first spacer 162 is configured to space apart the front side wall 116 and the first spring plate 152, and the second spacer 164 is configured to space apart the rear side wall 118 and the second spacer 164.

Additionally, referring to FIG. 7A, an attachment end 143 of the foldable screwdriver bit holder 144 is embedded in the front hammer cap 134. As a result, the front and rear hammer caps, together with the left ends of the first and second spring plates 152, 153 and the attachment end 143 of the foldable screwdriver bit holder 144, form the hammer mechanism 132 for the tool 110.

It is to be understood that the spacing mechanism 160 can be used independent of the hammer mechanism 132. In some embodiments, the spacing mechanism 160 can include a plurality of spacers parallel to each other. In other embodiments, the spacing mechanism 160 can include spacers disposed at the left end 124 of the tool 110, at the right end 126 of the tool 110 or at both the left and right ends 124, 126 for spacing apart two adjacent wall surfaces inside the channel 130. In one embodiment, the number of spacers disposed at one end of the tool 110 equals the number of the tool head 114 attached to the other end of the tool 110.

Referring to FIG. 7E, a hammer mechanism 332 is incorporated in a right end 326 of the tool 310. The hammer mechanism 332 includes an integral hammer cap member 334, and a spacing mechanism 360 disposed within a longitudinal channel defined between a front side wall and a rear side wall of the 310. In the embodiment depicted, the spacing mechanism 360 includes a first spacer 362 and a second spacer 364 extending rearwardly into the longitudinal channel from a surface of the hammer cap 334. Additionally, an attachment end 343 of a tool head attached to the right end 326 is embedded in the hammer cap 334. As a result, the hammer cap 334, together with the left ends of the first and second spring plates 352, 353 and the attachment end 343 of the third tool head, form the hammer mechanism 332 for the tool 310.

Referring to FIGS. 2A-D, 3A-D, 4 and 7C-D, a socket 176 is built into the hammer mechanism 132 as an additional screwdriver bit holder 181 for holding a screwdriver bit to tighten or loosen screws or bolts. The socket 176 is configured to be a second screwdriver bit holder that has an axis oriented perpendicular to the axis of the foldable screwdriver bit holder 144. Referring to the embodiment depicted in FIGS. 7A-D, a front portion of the socket 176 is formed in the front hammer cap 134 and is defined by a hammer member 173 of the front hammer cap 134 together with a rib 172 extending rearwardly from the hammer member 173, and a rear portion of the socket 176 is formed in the rear hammer cap 136 is defined by a hammer member 175 of the rear hammer cap 136 together with a rib 174 extending rearwardly from the hammer member 175.

In the embodiment depicted in FIG. 7E, the 334 is a one-piece member, a socket that has a similar configuration can be formed in the integral hammer cap member 334, except that the socket is not divided into a front portion and a rear portion.

In some embodiments, the socket 176 is capable of holding a screwdriver bit to tighten or loosen screws or bolts with increased force, compared to the screwdriver bit 186 held in the foldable screwdriver bit holder 144. In one embodiment, the socket 176 is capable of holding a screwdriver bit to loosen tight screws or to secure screws tightly. For example, a user can use the screwdriver bit held in socket 176 to torque a drywall screw behind the surface of a drywall panel or plywood panel before painting.

In the embodiment depicted, the socket 176 is configured to extend from a front surface of the front hammer cap 134 toward a rear surface of the rear hammer cap 136, and the portion of the socket 176 in the front hammer cap 134 has a hexagon-shape through hole. As shown in FIGS. 7C-D, corresponding to the socket 176 in the front hammer cap, an opening 179 is formed in the rear hammer cap 136. In some embodiments, a largest diameter of the socket 176 is greater than a largest diameter of the opening 179. As a result, the opening 179, while allowing the user to hang the tool on a wall, can act as a stopper to prevent the screwdriver bit from extending into the opening 179, and thus allows the additional screwdriver bit holder 181 to properly hold a screwdriver bit. It is to be understood that the socket 176 can include a pass-through socket or partially-pass-through socket, as long as the socket 176 can be configured to hold a screwdriver bit. In the depicted embodiment, the socket 176 is also configured for hanging the tool 110.

The fasteners extend between the side walls 116, 118 and through the hammer caps 134, 136, the spring plates 152, 153 and the 143, thus securing the hammer mechanism 132 in place and securing the side walls 116, 118 together at the right end 126 of the tool 110.

A friction reduction mechanism 123 can be incorporated in the tool 110. In the embodiment depicted in FIGS. 4 and 6C, one of the first and second spring plate 152, 153 has a point-to-surface contact with its respective tool head 114, when the tool head is pivoted between the folded position and the extended position, to avoid large surface contact. As a result, the friction occurred between the spring plate 152 or 153 and its respective tool head 114 during the pivotal movement of the tool head 114 can be reduced. In the embodiment depicted, the friction reduction mechanism 123 takes the form of a convex radius disposed at an inner corner of the left end 169 of the spring arm 159 of the spring plate 153. However, it is to be understood that the friction reduction mechanism 123 can take other forms to create a point-to-surface contact to reduce friction.

Referring to FIGS. 4 and 7A, a clip 138 can be attached to a side wall surface of the tool 110 to permit attachment of the tool 110 to the user's belt or pocket. It is to be understood that the side wall surface the clip 138 is attached to can be a wall surface of either the front side wall 116 or the rear side wall 118.

In the embodiment depicted, the clip 138 can be attached to a side wall surface of the tool 110 by the first pivot pin 141 located at the left end of the tool 110 or the second pivot pin 149 located at the right end 126, by which a pivotable tool head is also attached. In an alternative embodiment as depicted in FIG. 8, a clip 438 is attached to a wall surface of a left side wall 416 or a right side wall 418 by a separate fastener 437, such as a screw, so that it can be removed more easily if the user chooses to only put the tool in their pocket.

A grip-enhancing mechanism 166 can be incorporated into the handle 112. In the embodiment depicted in FIGS. 2A-D, the grip-enhancing mechanism 166 includes recessed panels 167 and unrecessed panels 168 disposed alternately along the top and bottom edges 120, 122 of the tool 110. In some embodiments, all of the recessed panels 167 have a similar height Hr and a width Wr, and all of the unrecessed panels 168 have a similar height Hu and a similar width Wu, with Hr being smaller than Hu and Wr being similar to Wu. In some embodiments, the width Wr or Wu is greater than either the height Hr or the height Hu. In some embodiments, each of the width of a recessed panel 167 and the width of an adjacent unrecessed panel 168 is smaller than a width of a finger that holds the handle. However, it is to be understood that the specific configuration of the alternating recessed panels and unrecessed panels can vary as long as a nonslip grip is created for handling the tool 110, such as cutting, scraping, etc.

In some embodiments as shown in FIGS. 3A-D, the grip-enhancing mechanism 166 can further include a layer of grip-enhancing material, e.g., a softer material coated on the side walls 116, 118 or the edges 120, 122 to create a nonslip grip for performing tasks, such as cutting, scrapping, etc., and provide a good hand feeling. In some embodiments, the grip-enhancing mechanism 166 can include surface roughening, such as knurling, on the side walls 116, 118 or the edges 120, 122 to increase a user's grip on the handle and prevent slipping. It is to be understood that the options for the grip-enhancing mechanisms 166 mentioned in the above paragraphs can be combined or used separately as desired.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art with no more than routine experimentation, and all such modifications and equivalents are believed to be within the spirit and scope of the disclosure as defined by the following claims.

What is claimed is:

1. A hand tool comprising:
an elongate handle having first and second side walls defining first and second edges and first and second ends, and a channel formed between the first and second side walls and extending through the first edge;
an elongate tool member secured to the first end of the handle by a pivot, whereby the tool member is pivotable between a folded position at least partially within the channel, and an extended position outside of the channel, wherein the tool member defines first and second side surfaces, first and second longitudinal edges and an orthogonal edge at an end of the tool member opposite the pivot; and
a utility knife secured to the first end of the handle by the pivot.

2. The hand tool of claim 1, further comprising:
a foldable screwdriver bit secured to the second end of the handle by second pivot.

3. The hand tool of claim 1, further comprising:
a spare tool retainer formed in the first side wall of the handle generally perpendicular to the first and second edge.

4. The hand tool of claim 1, further comprising:
a screwdriver bit holder oriented in a thickness direction of the handle.

5. The hand tool of claim 1, wherein the elongated tool member includes a finger actuation loop.

6. The hand tool of claim 1, wherein the elongated tool member includes a finger actuation knob.

7. The hand tool of claim 1, wherein the utility knife includes a finger actuation rib.

8. The hand tool of claim 1, wherein the elongated tool member includes a concave edge.

9. A tool comprising:
a handle having first and second side walls defining a first edge, and a channel formed between the side walls and extending through the first edge;
a tool member pivotally secured to the handle by a pivot at a first end of the handle, the tool member being pivotable between a folded position wherein the tool member is at least partially within the channel, and an extended position wherein the tool member is outside of the channel, and the tool member defining first and second side surfaces and a first longitudinal edge; and
a utility knife secured to a first end of the handle by the pivot at the first end.

10. The tool of claim 9, further comprising:
a foldable screwdriver bit secured to a second end of the handle by second pivot, the second end of the handle opposite the first end of the handle.

11. The hand tool of claim 9, further comprising:
a spare tool retainer formed in the first side wall of the handle generally perpendicular to the first edge.

12. The tool of claim 9, further comprising:
a screwdriver bit holder oriented in a thickness direction of the handle.

13. The hand tool of claim 9, wherein the tool member includes a finger actuation loop.

14. The hand tool of claim 9, wherein the tool member includes a finger actuation knob.

15. The hand tool of claim 9, wherein the utility knife includes a finger actuation rib.

16. The hand tool of claim 9, wherein the tool member includes a concave edge.

17. A method for assembling a hand tool, comprising:
securing an elongate tool member by a pivot at a first end thereof to a first end of a handle; and
securing a utility knife by the pivot at the first end thereof to the first end of the handle.

18. The method of claim 17, wherein the elongated tool member includes first and second side surfaces, first and second longitudinal edges and an orthogonal edge at an end of the tool member opposite the pivot.

19. The method of claim 17, wherein the elongated tool member further includes a concave edge.

20. The method of claim 17, wherein the elongated tool member includes a finger actuation mechanism.
